(19) United States
(12) Patent Application Publication
(10) Pub. No.: US 2012/0159599 A1
(43) Pub. Date: Jun. 21, 2012

(54) Personalized Multifunctional Access Device Possessing an Individualized Form of Authenticating and Controlling Data Exchange

(76) Inventors: Thomas Szoke, Apopka, FL (US); Daniel Fozzati, Boston, MA (US); Andras Vago, Budapest (HU)

(21) Appl. No.: 13/393,852

(22) PCT Filed: Sep. 2, 2010
(86) PCT No.: PCT/US10/47634

§ 371 Date: Mar. 2, 2012

Related U.S. Application Data
(60) Provisional application No. 61/275,945, filed on Sep. 4, 2009.

(51) Int. Cl. G06F 21/00

(52) U.S. Cl. 726/7

(57) ABSTRACT

A personalized multifunctional access device that possesses an individualized form of authenticating and controlling data exchange following a unique authentication of a user by the access device, wherein the access is further disposed to create a secure exchange environment for a user through pairing with a corresponding medium and subsequent authentication.

### CROSS REFERENCE TO RELATED APPLICATION

This application claims priority to and takes the benefit of U.S. Provisional Application No. 61/275,945 filed on Sep. 4, 2009, the contents of which are hereby incorporated by reference.

### BACKGROUND OF THE INVENTION

### Field of the Invention

This invention relates generally to electronic devices and a corresponding authentication system to create a secure environment, and more particularly to a personalized multifunctional access device possessing an individualized form of authenticating and controlling data exchange.

### BACKGROUND OF THE INVENTION

Mobile electronic devices, including, but not limited to mobile phones, personal digital assistant's (“PDA”), Smartphone's and mobile computers are subject to a constantly changing environment by the individual users of these devices.

As a result, the type of information which may be stored on these devices is usually purposefully limited, due to the lack of security measures present on the device. The lack thereof inhibits a user's ability to place trust in such a device for a variety of transactions, including, but not limited to secure storage of sensitive data, mobile commerce and/or communication with a separate device.

As these devices become increasingly connected to a user's Internet based identity, the need to store personal, vital and perhaps confidential information heightens, and as a result, mobile device security follows a rudimentary route.

Typically, mobile devices employ a Personal Identification Number (“PIN”), or a password that a user sets up for use to access a device and any accompanying files contained therein. Furthermore, a mobile device may utilize a combination of keyword and/or picture identification, wherein a user types a keyword and identifies a preset picture out of several options. Another example may be found in a mobile device possessing an embedded security feature, wherein a biometric or retina scanner is contained within the same device.

The first approach described above is limited in scope and security, as the level of protection relies entirely on the user to maintain the secrecy of the PIN/password and/or of the picture. Therefore, once an unwanted party knows the

PIN/password and picture combination, the entire security of the device, including personal information contained therein, may be compromised.

This single layered barrier to entry may potentially allow further unwarranted access since users tend to recycle their pin and passwords for other accounts. Lastly, a device with an embedded biometric and/or retina scanner may be compromised, along with its on-board memory, through physical means of tampering. This weakness may be due to the nature of manufacturing a consumer mobile device at high volume, wherein tamper-proof manufacturing is simply not feasible. Ultimately, the problem inherent in mobile device security is that the majority, if not all, of responsibility to maintain a secure environment is placed on the single mobile device and its user.

### SUMMARY OF THE INVENTION

The instant invention, as illustrated herein, is clearly not anticipated, rendered obvious, or even present in any of the prior art mechanisms, either alone or in any combination thereof.

The instant device provides for a personalized multifunctional access device possessing an individualized for authenticating and controlling a data exchange for a user.

In one embodiment of the instant device, the personalized multifunctional access device is disposed to possess the function of a universal access control device, wherein the device may utilize a wireless communication technology such as Radio Frequency Identification (“RIFD”) and/or Near Field Communication (“NFC”), as well as both Internet and/or intranet communication. In one embodiment of the instant device, the above-described forms of communication may be utilized either independently or in any combination thereof.

In yet another embodiment of the instant device, the personalized multifunctional access device may wirelessly communicate with a corresponding mobile device or separate medium, including but not limited to a mobile phone such as a Smartphone. In this embodiment, communication between the devices may be dyadic in nature, wherein the typical roles of master and slave are altered, either temporarily, or for the entire duration of communication. An example of this behavior may occur in a situation wherein typically the master device, or rather, the device with which a user would normally interact with directly (such as a mobile phone), rescinds computational control over the data, and allows the attached device, the personalized multifunctional device of the instant invention, to perform the computational tasks normally associated with a master device.

A further example and embodiment of the inverse master and slave relationship created by the instant device may occur during an authentication procedure wherein an individual user's identity may be authenticated through an onboard fingerprint reader located within the personalized multifunctional device. In this embodiment, the instant invention is disposed to perform a computational procedure to authenticate the individual user, and upon authentication and validation that the user is known to the personalized multifunctional device, the instant invention allows for a connected device, such as a mobile phone, to enable and proceed with interaction by the user.

In yet another embodiment, the instant device is disposed to control a corresponding device the instant invention may be paired to by either a wireless or a wired communication.

In yet another embodiment, the instant device may include an embedded operating system, wherein the operating system is disposed to control the instant invention and all paired devices.

In yet another embodiment, the instant device may include a magnetic stripe reader, either internally built in or externally attached, wherein the magnetic stripe reader is disposed to allow a user of the instant invention to input a plurality of credit card information stored on a corresponding credit card magnetic strip.

In yet another embodiment, the instant device is disposed to function as a wireless device, wherein the wireless device may include a fingerprint reader, an embedded operating system, a processor, and a Bluetooth communication module, preferably for attachment to a keychain to allow for the device to be pocketable.

A primary object of the instant device is to create an individualized system for a secure transfer/transaction environment, wherein responsibility for the system is preferably divided into two prongs or modules. In this embodiment, each prong of system is disposed to be provided a limited amount of responsibility so as to remain interdependent of the other prong. Notably, the first prong is a personalized multifunctional access device, wherein the personalized multifunctional access device is disposed to preferably include the aforementioned biometric and/or retina scanner. The instant device may also include a secure on-board memory and an NFC wireless transmitter to enable contactless communication between the instant device and a separate medium to enable a plurality of data exchange. The second prong is the user of the personalized multifunctional access device, wherein the user is disposed to create and maintain the secure environment system.

In one embodiment, the individualized system may incorporate a third prong, wherein a desktop computer software application is disposed to be in data communication with the personalized multifunctional device, preferably through a connection means to the multifunctional device. The computer preferably is disposed to retrieve, transmit and process data with the multifunctional device, in addition to verifying a user's identity through the biometric and/or retina scanner located with the multifunctional device.

In yet another embodiment of the instant device, the personalized multifunctional access device may be utilized to create the aforementioned secure environment by means of pairing various hardware components together. A means by which the multifunctional access device may accomplish this, may be through confirming the presence of the multifunctional access device itself, and the type of hardware elements paired with the access device (i.e. mobile phone, computer etc.); capturing the unique identifiers of each hardware device (i.e. serial number/Subscriber Identity Module “SIM” data/International Mobile Equipment Identity “IMEI” number etc.) and combining these with a plurality of identification values preferably obtained from the fingerprint of a user, thereby associating the user with the multifunctional device and the corresponding hardware elements.

In yet another embodiment, the personalized multifunctional access device may compute, by means of mathematical cryptography, a plurality of data contained within the device, and subsequently may encrypt the data by using a plurality of data values taken from a user's fingerprint, a mobile device's SIM card, serial number, and IMEI, in combination with the multifunctional devices own serial number and/or unique identifiers in order to create a set of public and private keys.

In yet another embodiment, the instant device may allow for a user of the personalized multifunctional access device to access a corresponding desktop computer software application by verifying the user's identity through a biometric fingerprint scan. Furthermore, the multifunctional access device may be disposed to transmit and receive a plurality of data from the desktop computer application. In one embodiment, the transmission and receipt of data may occur during an initial pairing of the various components of the secure environment, between the user and the personalized multifunctional access device. Once the data value sets from a user's fingerprint input and the various devices' serial/IMEI/SIM numbers is obtained, the personalized multifunctional device may be connected via a Universal Serial Bus (“USB”) connection to a corresponding computer. In this embodiment, the computer may initiate data communication with the multifunctional access device, upon authorization by the user to proceed. The multifunctional access device may then receive, from the computer application, the computer's serial number. Once received, the multifunctional access device may combine all of the aforementioned data sets to create a pair of mathematically encrypted public and private keys. Subsequently, the personalized multifunctional access device may transmit one or both of the public and private keys to the computer application via the USB connection.

There has thus been outlined, rather broadly, the more important features of a personalized multifunctional access device possessing an individualized form of authenticating and controlling data exchange in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

FIG. 1 illustrates a block diagram of one embodiment of a personalized multifunctional access device possessing an individualized form of authenticating and controlling data exchange.

FIG. 2 illustrates a flow diagram of an initial pairing process for the creation of a secure environment between the multifunctional access device and a user of the device.

FIG. 3 illustrates a flow diagram of one embodiment for the creation of a secure environment between the multifunctional access device and a corresponding desktop computer.

FIG. 4 illustrates a process diagram of one embodiment of the instant device for authentication of a user to enable a plurality data exchange.

FIG. 5 illustrates a flow diagram for one embodiment of verification of the personalized multifunctional access device with a user of the device.

FIG. 6 illustrates a diagrammatic perspective view of one embodiment of a web portal in data communication with the multifunctional access device, and a user of the device.

### DETAILED DESCRIPTION OF THE PREFERRED EMBODIMENT

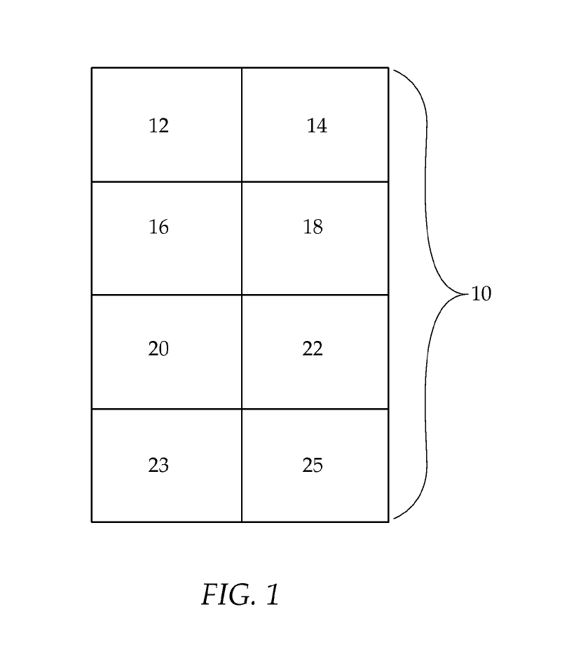

FIG. 1 illustrates a block diagram of the instant invention 10, wherein the instant invention discloses a personalized multifunctional access device 10 possessing an individualized form of authenticating and controlling data exchange, preferably with a separate medium in data communication with the multifunctional access device 10. In a preferred embodiment, the access device 10 is paired with a corresponding mobile device or separate medium; in one embodiment the access device 10 is disposed to be connected to the separate medium or mobile device and in one embodiment the access device 10 is in data communication with the separate medium or mobile preferably via Bluetooth®. In one embodiment, the multifunctional access device 10 includes a biometric fingerprint module 12 disposed to verify and capture the identity of a user of the access device 10. Additionally, the multifunctional access device 10 may contain a NFC module 14, wherein the NFC module 14 is disposed for data communication with a plurality of separate mediums; in one embodiment the NFC module 14 is disposed to allow the multifunctional access device 10 to provide for secure data exchange. Furthermore, the NFC module 14 may transmit data to and from the multifunctional access device 14 to a third party point-of-sale (“POS”) terminal; for example, the data transmitted may be financial information, such as the amount a user paid for an item at a grocery store, or any other comparable application. Another embodiment may include a plurality of user identity information which may be scanned wirelessly by a third party to grant admittance to an event, such as virtual tickets that a user bought for a concert or sporting event. Moreover, a user of the multifunctional access device 10 may utilize the NFC module 14 to transmit the user's information to a third party medium, including, but not limited to a loyalty and/or membership card information, (i.e. movie rentals and hotels), as well as a plurality of debit card, credit, and transit card information. As previously described, and in further detail below, this information may be encrypted and decrypted by the multifunctional access device 10 upon authentication and usage by an individual.

Furthermore, the personalized multifunctional device 10 may include a plurality of light emitting diodes 16 (“LED”), wherein the LED's 16 are disposed to indicate the status of an operation occurring via the multifunctional access device 10, preferably in conjunction with a paired separate medium or mobile device. In one embodiment, the LED's 16 may be configured by a user of the multifunctional access device 10 to indicate for example, a mood of the user, or perhaps to match the color of a purse or the enclosure of a corresponding mobile device or separate medium. Also, the multifunctional access device 10 may include a plurality of sound tunnels 18 disposed to preferably channel a quantity of sound from a microphone or speaker located on a paired mobile device, thereby preventing hindrances of any audio output input from the mobile device.

In one embodiment, the multifunctional access device 10 includes a Micro Secure Digital (“SD”) card slot 20, wherein the card slot 20 enables a user of the access device 10 to transfer a plurality of data to and from a MicroSD card. Also, the multifunctional access device 10 may have an inductive magnet to allow for wireless charging of the mobile device via a charging pad.

In yet another embodiment, the personalized multifunctional access device 10 may include a plurality of numbered onboard non-removable storage modules 22, wherein each non-removable storage module 22 is disposed for the secure storage of a user's profile data, along with any third party/proprietary information from a separate medium that the user may deem sensitive in nature.

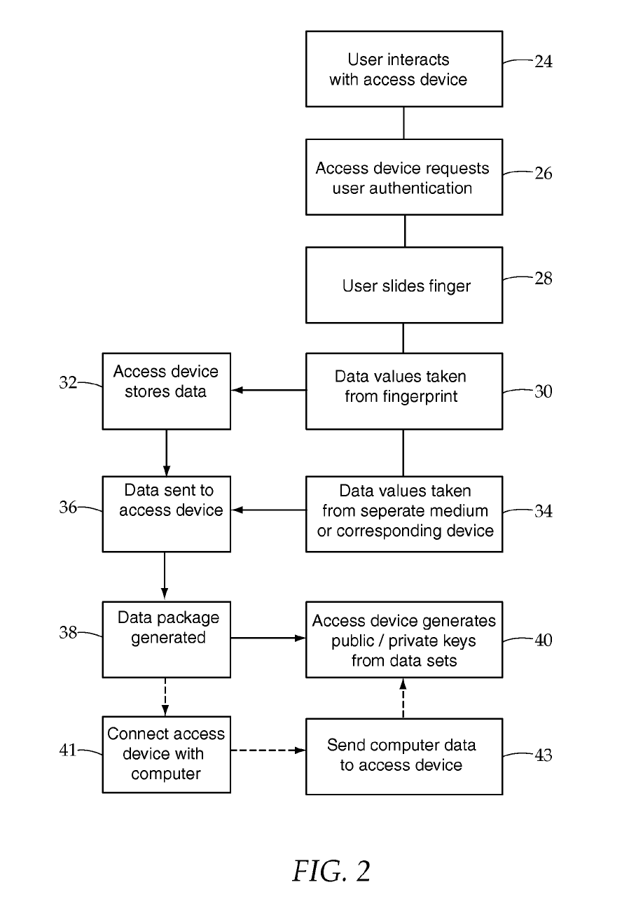

FIG. 2 illustrates a flow diagram for the creation of a secure environment between the personalized multifunctional access device 10 and a separate medium to allow for personalized authentication and controlling of data exchange by a user with a corresponding separate medium or mobile device. In one embodiment, the personalized multifunctional device 10 may be utilized to create the aforementioned secure environment by means of pairing various hardware components together. One means by which the multifunctional access device 10 may accomplish the creation of this environment, may be by confirming the presence of the access device 10 itself and the type of corresponding hardware elements paired to the device 10 (i.e. mobile phone, computer etc.); capturing the unique identifiers of those hardware devices (serial number/SIM data/IMEI number etc.); and combining these identifiers with the data values obtained from a plurality of authentication data of the user to exclusively associate the user with those hardware elements. At step 24, a user initiates contact with the multifunctional access device 10. Upon initial contact, at step 26, a user is prompted for authentication with the multifunctional access device 10, preferably by obtaining a fingerprint of the user via the biometric module 12. Therefore, following the request for authentication, at step 28, the user provides a fingerprint or other authentication data values for authentication by preferably sliding the user's finger on the biometric module 12. At step 30, a plurality of data values are obtained from the user's fingerprint for use in both authentication and pairing with a separate medium and/or mobile device. Next, at step 32, the data values obtained from the user's fingerprint are stored on the multifunctional access device 10. At step 34, a plurality of data values from the separate medium in data communication with the multifunctional access device 10, or a corresponding mobile device is obtained; this information includes but is not limited to the serial number/SIM/IMEI numbers. At step 36, the data values obtained previously in step 34 are disposed to be transmitted to the multifunctional access device 10. Upon receipt of the data values from the corresponding mobile device or separate medium by the multifunctional access device 10, at step 38 the multifunctional access device 10 is disposed to generate a data package containing the above-described information. At step 40, a secure access module processor 25 located on the multifunctional access device 10 is disposed to generate both a public and private key based on the data package provided. Optionally, in an embodiment, wherein a desktop computer is utilized for an additional prong of a secure environment, at step 41, the access device 10 is connected to the computer, and at step 43, the computer is disposed to transfer the serial number of the computer to the access device 10.

In one embodiment, the multifunctional device 10 may compute, by means of mathematical cryptography, the data contained in the device 10, and may encrypt the data by using data values taken from the user's fingerprint, the mobile devices SIM card, the mobile devices serial number, the mobile devices IMEI number, in combination with multifunctional access device's 10 own serial number and/or unique identifiers, in order to create a set of public and private keys.

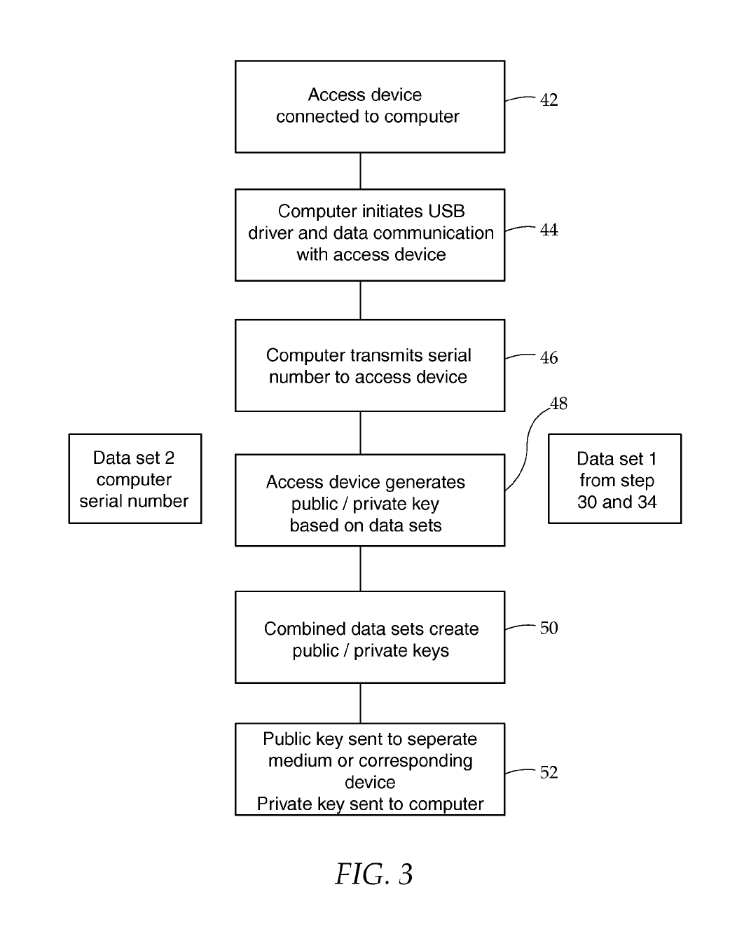

FIG. 3 illustrates a block diagram of one embodiment for the creation of a secure environment between the multifunctional access device 10 and a corresponding desktop computer. In this embodiment, a desktop computer may be utilized as the third prong in the creation of a secure environment to allow for the authentication and control of data exchange by the personalized multifunctional access device 10. In this embodiment, the multifunctional access device 10 may allow the user to access a related desktop computer software application by verifying a user's identity through a biometric fingerprint scan. Furthermore, the multifunctional access device 10 is disposed to be in data communication with the desktop computer to enable the device 10 may transmit and receive data from the desktop computer application. At step 42, the multifunctional device 10 is connected to a desktop computer preferably via a USB connection. Following connection, at step 44, the desktop computer initiates a USB driver and commences data communication with the personalized multifunctional access device 10.

At step 46, the desktop computer transmits the serial number of the computer to the multifunctional access device 10. At step 48, the multifunctional access device 10 is disposed to create both a public and private key based on the plurality of information obtained in previously obtained in steps 30 and 34, in combination with the serial number of the computer. At step 50, the combined data sets create public and private keys, and finally at step 52, the private key is distributed to the computer, and the public key is distributed preferably to a corresponding mobile device or separate medium.

An example of the sending and receiving of data between devices may occur during the initial pairing of the various components, when the pairing is initiated between the user and the multifunctional access device 10. After having obtained data value sets from both a user's fingerprint input and the various devices' serial/IMEI/SIM numbers, the multifunctional access device 10 may be connected via USB connection to the user's computer. The computer may then initiate USB communication with the access device 10 which the user may then authorize to proceed. The multifunctional access device 10 may then receive from the computer application, the computer's serial number. Once received, the access device 10 may combine all these aforementioned data sets to create a pair of mathematically encrypted public and private keys. The access device 10 may then deliver, one or both, of these public and private keys to the computer application via aforementioned USB connection.

Finally, after the aforementioned pairing is complete, in this embodiment, the desktop computer application may have the feature of requesting, from that point forward, the user's fingerprint authentication by means of attaching the multifunctional access device 10 via the USB connection and sliding the user's designated finger on the biometric module 12. Moreover, the personalized multifunctional device 10 may enable the user to utilize a plurality of applications on a corresponding attached mobile device by first verifying the user's identity through a biometric fingerprint scan.

In yet another embodiment, the personalized multifunctional access device 10 is disposed to enable a tiered level of access to various types of data found either on a user's corresponding mobile, a desktop computer application, or a separate third party medium. The plurality of data may be accessible through a combination of one or more biometric fingerprint scans and/or gesture based inputs, wherein a user of the multifunctional access device 10 may shake the attached mobile device in a user preset pattern to unlock access to data, subsystems of an application and/or as a means for a user to input data. Furthermore, the personalized multifunctional access device 10 is disposed to provide a means for storage of a plurality of user data generated by third party applications on an attached mobile device, or through a separate medium, when a third party may be granted access to the multifunctional access device 10 by both the user and the personalized multifunctional access device 10.

In yet another embodiment, the multifunctional device 10 is disposed to function as a virtual representation of cash currency and/or legal tender that the user has electronically transferred to the multifunctional access device 10 preferably via the magnetic stripe reader 23. The multifunctional access device 10 may display the amount transferred and/or the balance to be debited accordingly as the user may choose to make a transaction with a merchant via the aforementioned NFC module 14 following the previously described identification and authentication of the user. An example of this embodiment may occur when the user of the multifunctional device 10 has transferred a quantity of cash currency and/or legal tender by electronic means to an account assigned to the multifunctional device 10. The device will display the balance, which may come in the form of an interface visualization where the appropriate nation specific currency is displayed graphically in the form of a single virtual bill or several virtual bills contained within a graphical interface representation of a wallet. However, as stated above, in order for a user of the multifunctional device 10 to obtain access to the wallet, the user will need to be authenticated by the device 10 by scanning their finger via the aforementioned biometric finger scanner 12, wherein upon acceptance of the user's finger, access may be granted and transactions allowed.

Furthermore, in this embodiment, the multifunctional access device 10 is disposed to accept and display several international currencies as the user is free to choose to have several types within the device 10. Additionally, should the user be in a country that does not accept the type of cash currency and/or legal tender contained in the access device 10, the user may be able to input the local currency price, and the access device 10 may display the conversion rate and the amount needed from the access device's 10 cash currency and/or legal tender to satisfy the balance needed.

In yet another embodiment, the personalized multifunctional access device 10 may feature the two aforementioned sound tunnels 18 as a means to augment and channel sound to and from the microphone and speaker locations of an attached mobile device. Preferably, the sound tunnels may be covered by a mesh grill to prevent lint, dust or other such debris from accumulating and subsequently blocking the sound waves.

In yet another embodiment, the personalized multifunctional access device 10 is disposed to serve as a storage repository for a corresponding mobile device application to allow a user of the multifunctional access device 10 to access and edit the associated user profile and information. This may come in the form of a list or graphical representation of a single profile or multiple profiles that a user may choose to possess, to accommodate for different categories of use. Furthermore, in separate embodiments, these lists may include, but are not limited to profiles for different countries, states and/or different cases in an exchange of credentials, which may for example be a supermarket rewards cards and/or video store rental cards.

In yet another embodiment, the personalized multifunctional device 10 may seek to acquire a time stamp from an attached mobile device to associate with a plurality of data exchange being achieved through the multifunctional access device 10. Furthermore, the multifunctional access device 10 may seek to acquire a plurality of location data including, but not limited to GPS coordinates from a corresponding mobile device's on-board GPS receiver, in the interest of associating the user's location with an activity or data exchange. Examples of such actions include, but are not limited to financial transactions, user initiated data entry, autonomous data entry, and instances of user duress etc.

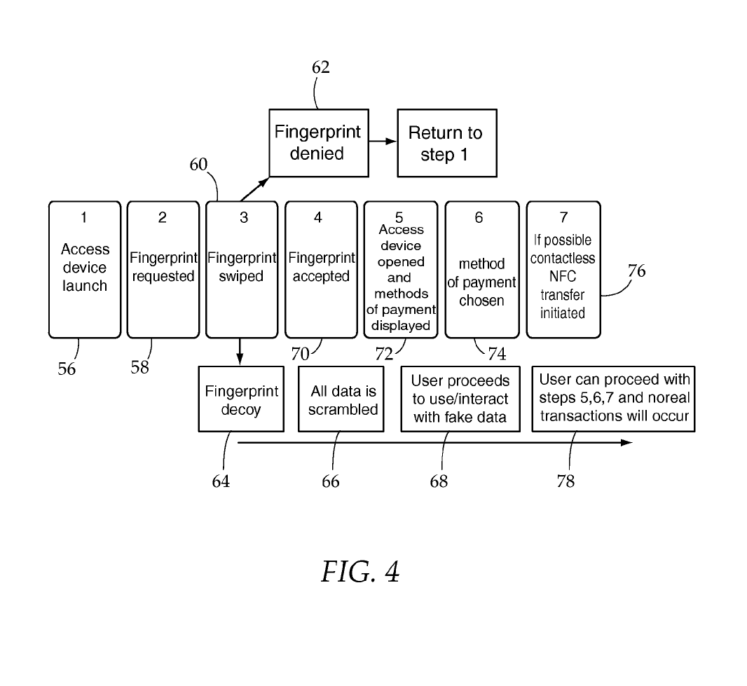

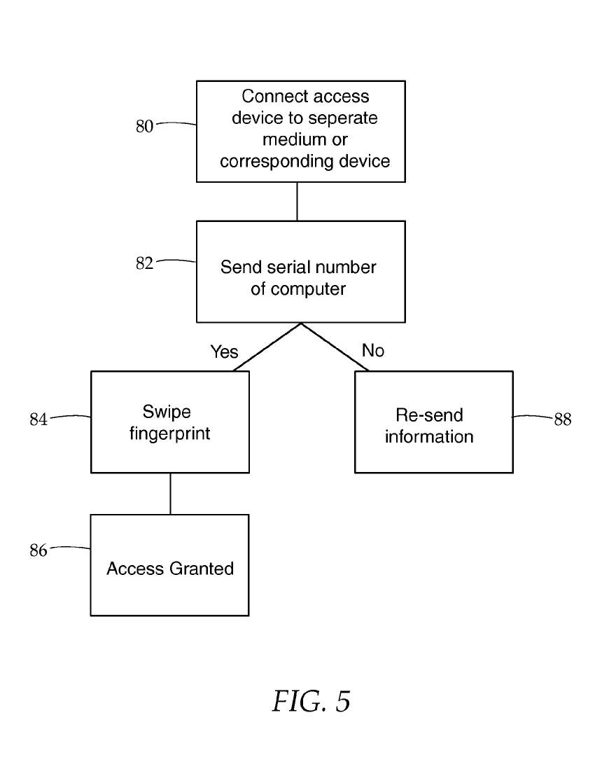

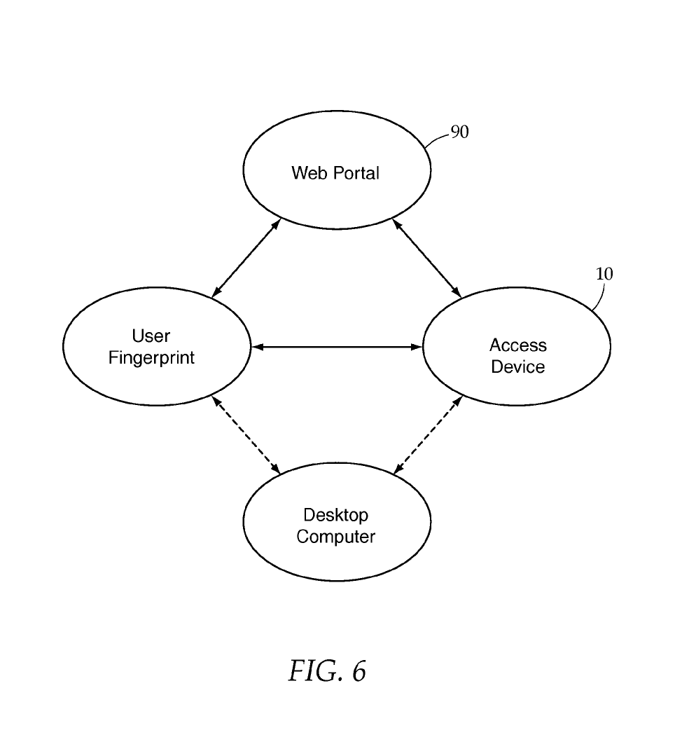

FIG. 4 illustrates a process diagram of one embodiment for protection of the personalized multifunctional access device 10 from unwarranted intrusion by a third party. Under this scenario, the multifunctional access device 10 may initiate a self-wipe response wherein the plurality of data stored on the multifunctional access device 10 is repeatedly overwritten numerous times to prevent any attempt at data recovery. Additionally, prior to initiating the aforementioned self-swipe response, the multifunctional access device 10 may seek to communicate an unwarranted attempt to tamper with the access device 10 by transmitting via data communication, a signal to a user's personal web portal 90 (see FIG. 6) to provide information to the user regarding this situation. Prior to the description in at step 56, verification may optionally occur with of a user with the multifunctional access device 10 (see FIG. 5). At step 56, a user may initiate contact with the multifunctional access device 10. Upon initial contact, at step 58, a user is prompted for authentication with the multifunctional access device 10, preferably by obtaining a fingerprint of the user via the biometric module 12. Therefore, following the request for authentication, at step 60, the user provides a fingerprint or other data for authentication by preferably sliding the user's finger on the biometric module 12. At step 62, if the fingerprint of an individual trying to authenticate with the access device 10 is denied, then the individual is returned to step 56 for another attempt at authorization. However, at step 64, when the fingerprint provided by a user is identified as a “decoy” or a predetermined fingerprint to signify unauthorized access, then at step 66, all of the data values contained within the multifunctional access device 10 are disposed to be scrambled to prevent access. At step 68, following data scrambling, the unauthorized user of the multifunctional access device 10 is allowed to proceed with a plurality of false data exchange, acting under the belief that access to the data on the access device 10 has been granted. In the event, the user of the multifunctional access device 10 is an authorized user, then following step 60, the fingerprint provided by the user will be accepted at step 70. Following acceptance of the user's fingerprint, at step 72 the user obtains authorized access to conduct a plurality of data exchange with a separate medium. At step 74, in the event that the user desires to conduct mobile commerce, a method of payment is selected. Optionally, at step 76, NFC 14 transmission of a plurality of data between the user and a separate medium may occur, if available. Finally, at step 78, an unauthorized user of the multifunctional access device 10 may proceed through steps 72-76 under the belief that actual data exchange took place, when in reality the data exchange conducted is false.

Therefore, as described above, the personalized multifunctional access device 10 is disposed to detect the use of a decoy or alternate finger used by the user in instances of duress in order to communicate to a corresponding mobile device application or separate medium, that the user is under duress and that all further user input should be disregarded.

In an alternate embodiment, the personalized multifunctional access device 10 may possess additional and/or alternative means of user authentication to assist or replace the necessity of a single fingerprint swipe. These alternative means may come in the form of several fingerprint swipes from various different fingers to invoke certain functions. An example of this would be when the user launches a mobile device application on a mobile device which is attached to the personalized multifunctional access device 10, and wherein the user is asked to swipe the pre-designated finger to authenticate. In this embodiment, the user may have the option to swipe different fingers which have been previously designated for certain functions, including, but not limited to, as the index finger to view a credit card balance information, or the ring finger to invoke the aforementioned electronic cash function.

Additionally, the personalized multifunctional access device 10 is disposed to possess the ability for the user to record, by means of a mobile device's built in accelerometer, the user's hand movement as a means to authenticate the user's identity. An example of this embodiment may occur when the user records a sequence of unique hand and/or arm movements to create a gesture based key. The user may establish a series of easy to memorize, yet uniquely succinct shakes of the hand in a variety of directions and/or to a particular rhythm. Furthermore, the user may chose to shake the device to the beat of the user's song of choice. Again, in these embodiments, the additional gestures etc. may serve as an additional layer of security for the personalized multifunctional access device 10 when in use with a separate medium and/or corresponding mobile device, when the user is conducting a plurality of data exchange.

Finally, in yet another embodiment, the personalized multifunctional access device 10 may invoke the use of the aforementioned LED 16 light bar to create a sequence of colors or lights that a user would predefine and ultimately enter to authenticate the user and gain access to the multifunctional access device 10. In this embodiment, a corresponding mobile device may present a graphical representation on a screen of the mobile device showing a mockup of the personalized multifunctional access device 10. As such, the multifunctional access device 10 may then display, on the LED 16 light bar, a random pattern of colors in a certain order. The user must then copy the pattern displayed on the multifunctional access device 10 and arrange them accordingly. This may serve as a means to verify that the user of the multifunctional access device 10 and a separate medium or corresponding mobile device is in fact a human and not a remote unwarranted cyber attack.

FIG. 5 illustrates a block diagram for one embodiment of possible verification of a user and the multifunctional access device 10, wherein the verification involves the optional third prong of a desktop computer. At step 80, the multifunctional access device 10 preferably corresponds with a mobile device or separate medium. At step 82, the previously obtained serial number of the desktop computer during initial pairing is transmitted. At step 84, if the serial number is transmitted, then the user is prompted to swipe a fingerprint for authorization. Finally, at step 86, access will be granted to an authorized user and verified fingerprint. In the event that the serial number is not transmitted, at step 88, the information is disposed to be re-sent.

FIG. 6 illustrates one embodiment of a web portal 90, wherein the web portal 90 is disposed to oversee the secure environment system created by a user and the multifunctional access device 10, and optionally a desktop computer. In one embodiment, the web portal 90 is disposed to receive a unique serial number of the access device 10, allowing the web portal to generate an anonymous key for the user of the access device 10.

In addition to the above-described embodiments, the personalized multifunctional access device 10 is disposed to be utilized in a variety of applications through the individualized authentification process and subsequent control of a plurality of associated data exchange. In one embodiment, the multifunctional access device 10 is disposed to function as an “electronic wallet”, wherein the multifunctional access device possesses the ability to store a plurality of virtual credit/debit cards, and subsequently to utilize the access device 10 for payment on POS terminals, preferably having a contactless interface. In yet another embodiment, the multifunctional access device 10 is disposed to allow for mobile commerce through a third party payment gateway provider through a payment proxy, in the absence or lieu of a contactless interface. In yet another embodiment, the multifunctional access device 10 is disposed to allow for payment via an EMV compliant contactless payment card.

In one embodiment, wherein the personalized access multifunctional device 10 is disposed to allow for mobile commerce and associated transaction following authentication of the user, payment may be accomplished by the magnetic stripe reader 25 or a functionally equivalent alternative, a contactless chip interface, including but not limited to EMV contactless cards, and contactless magnetic strip cards. Additionally, the multifunctional access device 10 in one embodiment is disposed to function as an EMV compliant credit/debit payment card. In yet another embodiment the personalized multifunctional access device 10 is disposed to function as an electronic identity card, to allow for both online and offline identification and authentification of an individual. In yet another embodiment, the multifunctional access device 10 may function as an independent mobile POS terminal, in connection with a corresponding mobile device or separate medium; this may occur in a situation wherein a mobile merchant may desire to accept contactless cards and/or for individuals who want to use a contactless bank card for online payment. In yet further alternate embodiments, the multifunctional access device 10 is disposed to function as a loyalty card, e-Ticketing, parking, Smart posters, Validating terminal, Mobile ticket vending machine, among other things, preferably through the use of the NFC module 14 located on the multifunctional access device 10.

Therefore, in summary the instant invention is disposed to function as an access device for a user to control a plurality of data exchange through an individualized authentication process unique to a user and the access device 10. In a preferred embodiment, the multifunctional access device 10 is disposed to be initially paired with a separate medium or mobile device, thereby enabling the multifunctional access device 10 to exert computational control over an attached mobile device. Moreover, while the pairing between the multifunctional device 10 and a corresponding separate medium need only occur once, in order for a user of the multifunctional access device 10 to gain use to the access device 10, an individualized authentication process is performed upon each usage.

Therefore, in summary the instant invention discloses a variety of unique solutions for a personalized multifunctional access device 10 that is disposed to function as an access device for a user to perform a plurality of data exchange following an individualized form of authentication of the user by the device.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

We claim:

1. A personalized multifunctional access device possessing an individualized form of authenticating and controlling data exchange comprising:
a biometric fingerprint module, wherein the fingerprint module is disposed to receive at least one of a user's fingerprints for use in an authentication process of the user;
a near field communications module, wherein the near field communications module is disposed for data communication with at least one separate medium;
a plurality of light emitting diodes, wherein the light emitting diodes are disposed to indicate a status of the performance of an operation on the access device;
a micro secure digital card slot, wherein the card slot is disposed to transfer and receive a plurality of data from a micro secure card;
at least one non-removable storage module, wherein each storage module is disposed for the secure storage of a user's profile data; and
wherein the access device is disposed to control at least one data exchange with a separate medium through the creation of a secure exchange environment following an individualized authentication process of a user by the access device.

2. The multifunctional access device of claim 1, wherein the access device is disposed to utilize a wireless communication for data exchange with a separate medium in order to exhibit the function of a universal access control device.

3. The multifunctional access device of claim 1, wherein the access device is disposed to be in data communication with a corresponding mobile device via wireless communication.

4. The multifunctional access device of claim 3, wherein the access device is disposed to exert computational control over the data exchange function of the corresponding mobile device.

5. The multifunctional access device of claim 3, wherein the access device is disposed to exert computational control over the corresponding mobile device during a user authentication procedure.

6. The multifunctional access device of claim 1, wherein the access device further comprises an embedded operating system disposed to control the access device and a plurality of corresponding medium.

7. The multifunctional access device of claim 1, wherein the access device further comprises a magnetic stripe reader disposed to enable a user to input a plurality of information stored on magnetic strip card.

8. The multifunctional access device of claim 7, wherein the plurality of information relates to a user's credit card information.

9. The multifunctional access device of claim 1, wherein the access device further comprises a plurality of sound tunnels disposed to channel a quantity of sound from a microphone and speaker located on a corresponding mobile device.

10. A method for the creation of an individualized system for a secure data exchange environment utilizing the multifunctional device of claim 1, wherein control responsibility for the system is divided into prongs, the steps comprising:
initiating contact with the access device by a user;
prompting an authentication request of the user by the access device;
inputting a plurality of authentication data for receipt by the access device;
storing the authentication data on the access device;
obtaining a plurality of authentication data from a corresponding medium for receipt by the access device;
generating a data package from the authentication data for the user and the corresponding medium by the access device; and
creating a public and private key by the access device based on the data package generated.

11. The method of claim 10, wherein the plurality of authentication data provided by a user is selected from the group consisting of at least one fingerprint, a unique light emitting diode combination, a unique hand gesture with the access device by a user or any combination thereof.

12. The method of claim 10, further comprising the steps of:
connecting the access device to a corresponding desktop computer via a universal serial bus connection;
initiating a universal serial bus connection by the computer to enable data communication with the access device;
transmitting a serial number of the desktop computer to the access device;
creating a public and private key from the serial number of the computer and the authentication data from the corresponding medium and access device;
distributing the public key to the corresponding medium; and
distributing the private key to the desktop computer.

13. The system of claim 10, wherein the authentication data of the corresponding medium includes at least one data value selected from the group consisting of a serial number, an international mobile equipment identity number and a subscriber identity module.

14. A method for a secure individualized authentication of a user with the multifunctional access device 1 the steps comprising:
initiating contact with the access device by a user;
prompting an authentication request of the user by the access device;
inputting a plurality of authentication data by the user for receipt by the access device;
storing the authentication data on the access device;
verifying the authentication data provided by the user; and
enabling the user to interact with the access device following verification of the user's authentication data.

15. The method of claim 14, wherein the multifunctional access device is disposed to initiate a series of events during authorized use, the steps further comprising:
verifying a pre-determined authentication data which indicates unauthorized use of the access device;
scrambling all of the data stored on the access device to prevent data recovery; and
enabling an authorized user to undertake a plurality of false data exchange on the access device.

16. The personalized multifunctional access device of claim 1, wherein the access device is disposed to be utilized in at least one application selected from the group consisting of an mobile commerce, a loyalty card, e-Ticketing, parking, Smart posters, a validating terminal, a mobile ticket vending machine, and an electronic identity card.

17. The personalized multifunctional access device of claim 16, wherein the mobile commerce application is disposed to allow for payment selected from the group consisting of a contactless interface, a third party payment gateway provider, an EMV compliant contactless card payment, an EMV compliant credit/debit payment card, and a contactless bank card.
